(19) United States
(12) Patent Application Publication
(10) Pub. No.: US 2016/0378089 A1
(43) Pub. Date: Dec. 29, 2016

(54) Logical Position Sensor

(71) Applicant: Siemens Aktiengesellschaft, Munich (DE)

(72) Inventors: Martin Lehofer, Plainsboro, NJ (US); Andreas Scholz, Unterschleissheim (DE); Andreas Schönberger, Bamberg (DE); Dong Wei, Edison, NJ (US)

(21) Appl. No.: 14/748,291

(22) Filed: Jun. 24, 2015

(51) Int. Cl. G05B 19/401; G05B 19/402

(52) U.S. Cl. CPC G05B 19/401; G05B 19/402; G05B 2219/37494

(57) ABSTRACT

A method of creating a logical position sensor for a component of an automation system includes an automation device determining (i) a unique identifier for the component; (ii) a geographical position of the component; and (iii) a logical position of the component within a production process performed by the automation system. The method further includes the automation device creating a logical position sensor for the component. The logical position sensor comprises a sensor interface which provides access to the unique identifier, the geographical position of the component, and the logical position of the component.

### TECHNICAL FIELD

The present invention relates generally to systems, methods, and apparatuses related to a logical position sensor which may be used within an automation system to collect and distribute information to applications executing within the automation system.

### BACKGROUND

Many tasks in automation systems depend on “logical” hierarchies/positioning of machines in a plant. For example, in a discrete manufacturing scenario it is important to know which machine is the next in a processing sequence, what is the utilization of preceding machines in a workflow, etc. Similarly, in a process automation scenario, it is important to know which sensors actuators are attached to the same pipes or tanks, etc. This kind of position information is typically not related to the geographic positioning of devices. For example, although two devices are geographically close they might be attached to different pipes and be very “distant” in a logical point of view (e.g., if pipes from two unrelated plants are bundled in a pipe barrel below road in a larger industrial plant). Similarly, two geographically distant sensors might be very close from a logical point of view. This may be the case, for example, for the valves on two ends of a (long) pipe or train presence sensors on a railroad track.

Automation systems are becoming more and more flexible in various ways, but different subsystem and components (e.g. Apps) have limited means to discover the current physical configuration (e.g. where is a certain sensor or actor located) or the logical location of a plant (e.g., in which part of the production process is this sensor currently located). This fact limits the implementation of advanced automation features like automated rerouting/workflow orchestration dynamically by the automation. In conventional systems, all possible routings/workflows must be manually engineered and implemented in the automation.

Moreover, factories and plants evolve during their lifecycle. For example, in a retrofitting project, it is very important to know where some critical actuator and sensors are located. Using such location information, these devices can be taken advantage of during the retrofitting. Otherwise, these devices may have to be removed and/or re-installed later.

Additionally, maintenance work is sometimes required to finish in a very limited downtime. For example, it is very important to locate some critical actuators and sensors in a short time in order to repair or replace them, especially when this maintenance work is outsourced to external partners. It is observed that, after years of operation, some actuators and sensors have been moved from their original place.

Often there are techniques to extract information out of conventional engineering systems, but these are based on specific interfaces or protocols provided by the vendors of the tools. These interfaces are different from tool to tool and typically closely resemble the internal storage structure used by the tool. Thus, they cannot be understood outside the context of the tool. Additionally, the necessary information is retrieved manually by an engineer visually inspecting diagrams, layouts or drawings. This approach is very time consuming and prone to error.

In process industries, P&ID (piping and instrumentation diagram/drawings) are the current method to describe the logical of the production progress. Often, these drawings are not linked to an engineering system. Even if they are linked, this information is not accessible during execution time. Fully dynamic reconfiguration of industrial automation system is not possible at the moment, as all possible configurations have to be engineered and implemented in advance. For maintenance work, especially when the work is outsourced, it takes time for maintenance professionals to locate the defect actuators and sensors to repair and replace them, with only design document and drawings at hand.

### SUMMARY

Embodiments of the present invention address and overcome one or more of the above shortcomings and drawbacks, by providing methods, systems, and apparatuses related to logical position sensors for maintaining logical position, geolocation, and other relevant information for devices operating in automation environments. Distributing this information via a “sensor” interface provides an easily understandable interface to application programmers and creates a level of abstraction that allows to present information from different tools (and different vendors) in a unified interface.

According to one aspect of the present invention, as described in some embodiments, a method of creating a logical position sensor for a component of an automation system include an automation device determining (i) a unique identifier for the component; (ii) a geographical position of the component; and (iii) a logical position of the component within a production process performed by the automation system. The automation device creates a logical position sensor for the component, wherein the logical position sensor comprises a sensor interface which provides access to the unique identifier, the geographical position of the component, and the logical position of the component. In some embodiments, the method further includes the automation device retrieving information from a Product Lifecycle Management System (PLM).

In some embodiments of the aforementioned method, the automation device also creates an additional logical position sensor for each additional component in the automation system. Each respective additional logical position sensor comprises a distinct logical position of a corresponding component within the production process performed by the automation system. In one embodiment, the aforementioned method further includes the automation device receiving a data processing request from an application associated with the component which requires information about a portion of the production process preceding and/or subsequent to the component. The automation device uses the logical position sensor and the additional logical position sensors to identify a preceding and/or subsequent component (as appropriate) in the production process. Then automation device sends the data processing request to the identified component.

The aforementioned method may include various other enhancements, refinements, or other additional features in different embodiments of the present invention. For example, in some embodiments, the automation device retrieves process configuration information associated with the production process from one or more of (i) a remote engineering and planning system; (ii) a local database; or (iii) one or more additional automation devices operably coupled to the automation device. Then, the logical position of the component within the production process may be determined based on the retrieved process configuration information. In some embodiments, the automation device comprises a computing device embedded within the component, while in other embodiments, the automation device comprises a computing device operably coupled to the component over a network. In some embodiments, the method further includes using an augmented reality application to overlay at least one of the unique identifier of the component, the geographical position of the component, and the logical position of the component on a live image of the component.

According to another aspect of the present invention, as described in some embodiments, an article of manufacture for creating a logical position sensor for a component of an automation system comprises a non-transitory, tangible computer-readable medium holding computer-executable instructions for performing the aforementioned method. This article of manufacture may further include instructions for any of the additional features discussed above with respect to the aforementioned method.

According to other embodiments of the present invention, a system for providing logical position information corresponding to a component of an automation system includes a data acquisition component, a database, and a sensor interface. The data acquisition component is configured to retrieve process configuration information associated with a production process from one or more remote sources such as, for example a remote engineering and planning system and/or one or more additional components of the automation system. The data acquisition component generates logical position information using the process configuration information. This logical position information comprises a logical position of the component in the production process. For example, in some embodiments, the logical position information includes a unique identifier for the component and a geographical position of the component. The logical position information may further comprises a first set of unique identifiers corresponding to components of the automation system directly preceding the component in the production process and a second set of unique identifiers corresponding to components of the automation system directly following the component in the production process. The database in the system is configured to store the process configuration information and the logical position information. The sensor interface is configured to provide access to the logical position information. In some embodiments, the data acquisition component, the database, and the sensor interface are included in a software application executing on the component.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 provides a system view of an automation system configured to use logical position systems on production devices, according to some embodiments of the present invention;

FIG. 2 provides an illustration of a logical position sensor, as it may be implemented in some embodiments;

FIG. 3 provides a diagram of a system that may be used for producing flavored coffee; and

FIG. 4 provides an example of how information from a logical position sensor can be utilized to display relative information about an automation component, according to some embodiments.

### DETAILED DESCRIPTION

Systems, methods, and apparatuses are described herein which relate generally to a logical position sensor which may be used within an automation system to collect and distribute information to applications executing within the automation system. Briefly, information is collected about a plants structure and organization from engineering systems. This information is processed and transformed so that it may be provided to applications running on an automation system in form of a logical position sensor. This logical position sensor presents information in an analogous way a GPS sensor provides geographical information to applications. Distributing this information via a “sensor” interface provides an easily understandable interface to application programmers and creates a level of abstraction that allows to present information from different tools (and different vendors) in a unified interface.

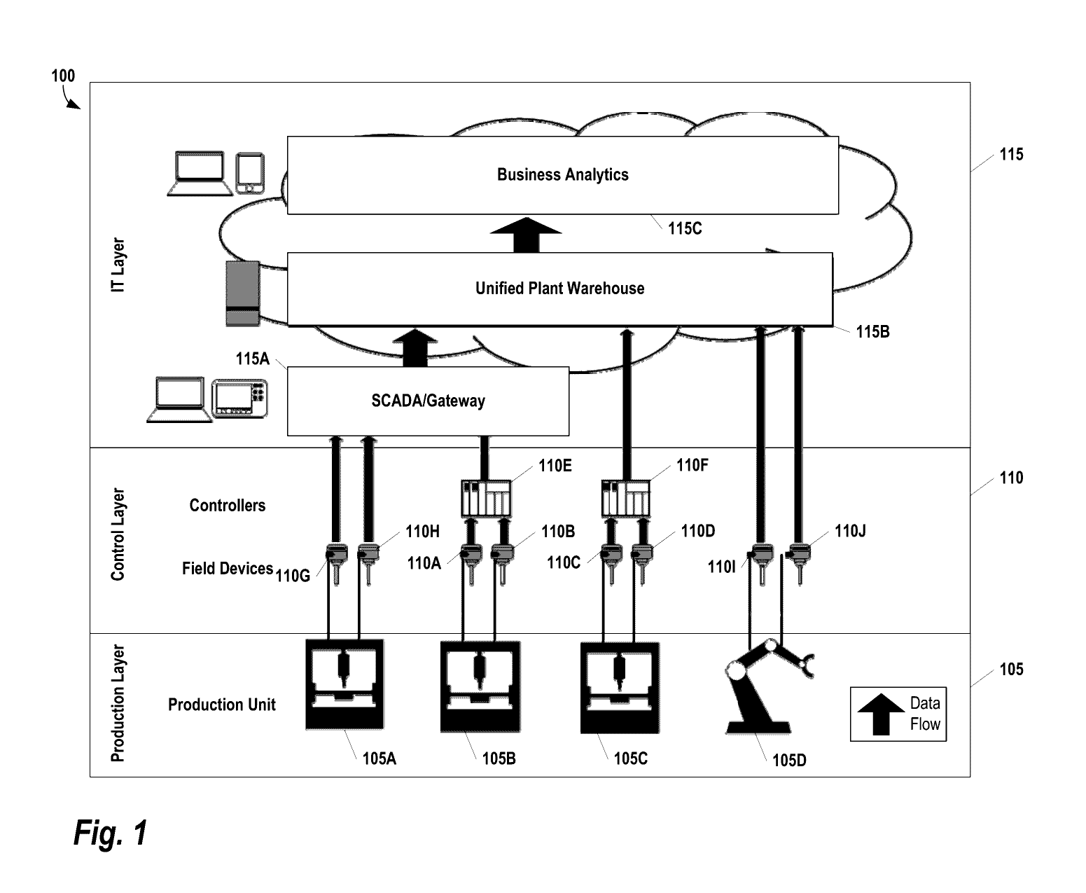

FIG. 1 provides a system view of an automation system 100 configured to use logical position systems on production devices, according to some embodiments of the present invention. This example conceptually partitions an automation environment into a Production Layer 105, a Control Layer 110, and an IT Layer 115.

Briefly, one or more production units (e.g., Unit 105A) operate at the Production Layer 105. Each production unit sends and receives data through one or more field devices (e.g., Field Device 110A) at the Control Layer 110. At the Control Layer 110, each field device may be connected to an Intelligent PLC (e.g., PLC 110E). Data received from the production units is transferred (either directly by the field devices or via a PLC) to the IT Layer 115. The IT Layer 115 includes systems which perform various post-processing and storage tasks. The example of FIG. 1 includes a Supervisory Control and Data Acquisition (SCADA) Server (or Gateway) Component 115A. This Component 115A allows an operator to remotely monitor and control the devices at the Control Layer 110 and Production Layer 105. Additionally, the SCADA Server Component 115A collects data from the lower layers 105, 110 and processes the information to make it available to the Unified Plant Knowledge Warehouse 115B. The Unified Plant Knowledge Warehouse 115B provides further processing and storage of the data received from the lower layers 105, 110. Various functionality may be provided by the Unified Plant Knowledge Warehouse 115B. For example, in some embodiments, the Unified Plant Knowledge Warehouse 115B includes functionality for generating analytics based on the data generated by the lower layers 105, 110. In other embodiments, the IT Layer 115 may include additional devices such as Product Lifecycle Management Systems (PLMs) and/or other systems for managing, planning and simulating the factory floor (not shown in FIG. 1).

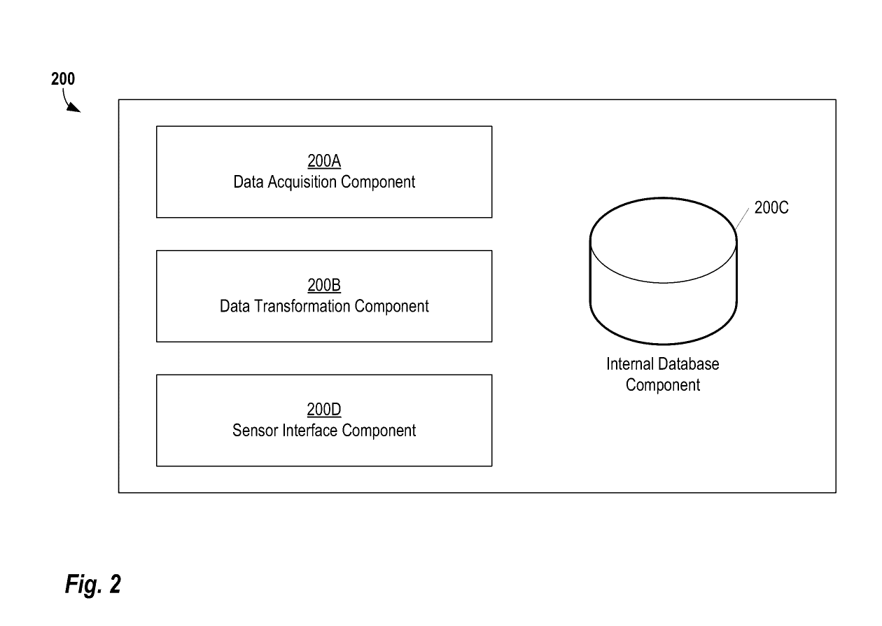

Each PLC 110E and 110F includes three basic portions: one or more processors, a non-transitory, non-volatile memory system, and a data connector providing input/output functionality. The non-volatile memory system may take many forms including, for example, a removable memory card or flash drive. The non-volatile memory system, along with any volatile memory available on the PLC is used to make data accessible to the processor(s) as applications are executed. This data may include, for example, time-series data (i.e., history data), event data, and context model data. Applications that may execute within the PLCs 110E and 110F are described in greater detail below with reference to FIG. 2. The data connector of PLC 110E is connected (wired or wireles sly) to Field Devices 110A and 110B. Similarly, the data connector of PLC 110F is connected to Field Devices 110C and 110D. Any field devices known in the art may be used with the PLC described herein. Example field devices that may be used with the PLC include, without limitation, pressure switches, sensors, push buttons, flow switches, and level switches. Note that the PLCs 110E and 110F may be integrated into the production environment piecemeal. For example, in FIG. 1, Production Units 105B and 105C are connected through their respective field devices to PLCs 110E and 110F, while Production Units 105A and 105D communicate directly through their respective Field Devices 110G, 110H, 110I, 110J to the Unified Plant Knowledge Warehouse 115B.

In order to track and manage the various components within the automation system 100, logical position sensors can be associated with control layer and production layer devices. As described in greater detail below with respect to FIG. 2, each logical position sensor may provide various contextual information regarding the device and its operations within the automation system. For example, a logical position sensor may be associated with Field Device 110A specifying its geolocation within the physical automation environment. Additionally, this logical position sensor may specify that the Field Device 110A is logically located between PLC 110E and Production Unit 105B in the production system. Thus, the logical sensor may be used to quickly understand the relationship between different components of an automation workflow even if additional physical components (e.g., pipes, valves, etc.) exist between the Field Device 110A PLC 110E and/or the Production Unit 105B.

In some embodiments, the logical position sensors for all the devices in the automation system 100 are configured and managed from a central location (e.g., Unified Plant Knowledge Warehouse 115B). When a new device is added to the automation system 100, an operator may manually create a logical position sensor for the device. In some embodiments, the creation process requires the manual input of all logical position sensor information, while in other embodiments manual input is limited to a core set of information (e.g., geolocation) and other information is learned based on the relationships between existing logical position sensors in the automation system.

In some embodiments, the logical position sensor is a software application configured to be executed on its corresponding device. For example, Field Device 110A may include computing hardware and an operating environment which allows it to run an application providing the functionality of a logical position sensor. The logical position sensor may then share sensor information using networking functionality provided on the Field Device 110A. In some embodiments, the other devices in the operating environment have similar applications running for their corresponding physical devices and information is shared between logical position sensors to gain a complete understanding of the automation system 100A. For example, a logical position sensor associated with the Field Device 110A may share information with the logical position sensor of Production Unit 105B which, in turn, may be used by the devices' respective logical position sensors to understand the physical relationship between the devices.

FIG. 2 provides an illustration of a Logical Position Sensor 200, according to some embodiments. This Logical Position Sensor 200 may be implemented, for example, as a discrete software application executing on a particular device. Alternatively, the Logical Position Sensor 200 may be one of several Logical Position Sensor instances being managed from a larger software application.

Data Acquisition Component 200 is configured to collect information about the automation system (e.g., system 100), either through manual input or through automatic discovery. For example, in some embodiments, the Data Acquisition Component 200 uses a network-based technique that extracts the information on-demand from a central server. In other embodiments, the device hosting the Logical Position Sensor 200 includes an internal database containing a relevant portion of the information about the automation system. In other embodiments, the Data Acquisition Component 200A uses a discovery-based system where information is “learned” by querying other devices installed in the automation system. Additionally, one or more of the aforementioned embodiments for information acquisition may be combined to create a hybrid solution.

The Data Transformation Component 200B is configured to translate between the data model used by different engineering tools used in the automation system and the standardized view used by the Logical Position Sensor 200. Providers of this component may include, for example, the vendors of the engineering tools providing this data. Alternatively (or additionally), the Data Transformation Component 200B may be configured by the developer of the Logical Position Sensor 200 to transform data between commonly used or standard data formats. In some embodiments, the Data Transformation Component 200B can be omitted if Data Acquisition Component 220A is already exporting the data in the required format.

An Internal Database Component 200C is used to store extracted information about the automation system. The Internal Database Component 200C is especially useful if the data acquisition process is “costly” (e.g., involves heavy computing, requires large bandwidth, is only possible at certain time slots, should be supervised due to security reasons, etc.). The typical workflows for cache updating can be implemented by the Internal Database Component 200C, starting from on-demand updates, timed updates, updates pushed from the engineering system, etc.

A Sensor Interface Component 200D facilitates access to the logical position of a device in the plant in a standardized way. The Sensor Interface Component 200D may include information such as, for example, a unique identifier of the virtual sensor and geo-spatial position information (e.g., GPS or shop floor coordinates). Additionally, in some embodiments, the Sensor Interface Component 200D also includes information about other sensors and devices in the environment, as identified by their own respective unique identifiers. Thus, for example, the Sensor Interface Component 200D may include a list of directly preceding unique identifiers, a list of parallel (alternative) unique identifiers, a list of directly following unique identifiers, and/or map of influencing unique identifiers (1:n) with influence descriptors (1:n). The Sensor Interface Component 200D may store this information or, alternatively, it may be dynamically generated based on knowledge of neighboring components. Consider, for example, a request to the Sensor Interface Component 200D for the 10 preceding devices in a particular production process. The Sensor Interface Component 200D can query its immediately preceding neighbor for information about its immediately preceding neighbor. This process can be repeated backward up the chain of components in the process until the 10^{th} device is known. At that point, the responses are generated in reverse and aggregated to determine the identifier of each device in the chain.

The exact methods offered by the Sensor Interface Component 200D may be standardized across a particular domain, thus allowing application to query for information in a uniform manner. Examples of methods that may be provided by the Sensor Interface Component 200D include, without limitation, queries for the next machines “in sequence” (e.g., the next machine on a conveyor belt or in a production sequence); queries for neighboring machines, (e.g., machines that have an indirect influence on a particular production process such as all machines that share the same buffer space); and/or queries for infrastructure (e.g., who is responsible for my power supply, who is responsible for material transport, etc.).

In some embodiments, the Logical Position Sensor 200 may also provide quantitative information via the Sensor Interface Component 200D. This could be used, for example, for ranking purpose such as selecting between multiple candidates for the next production step. Again, this metric does not have to rely on geographical distance but may also include other considerations such as energy cost for transport to the candidate. For example, it may be cheaper to transport fluids to one tank than the other if there are less (or more efficient) pumps involved or the difference in altitude is different.

Instead of hard-coding the sensors or actuators that an application in an automation system will read or write to, in some embodiments, the Logical Position Sensor 200 enables querying (e.g., via the sensor interface) of which sensor or actuator must be used in the current physical and logical configuration of the automation system. If an automation system uses transport components (e.g., pipes, cars, autonomous transportation systems, etc.), distance metrics can be used by the automation application to determine the feasibility of the current production route/workflow.

Sensor information may be maintained using any standard known in the art. For example, sensor information may be specified using semantic models expressed in standardized, formal, domain-independent languages. In one embodiment, knowledge representation Semantic Web standards are used. These standards provide a formal language to introduce classes and relations whose semantics are defined using logical axioms. One example of such a knowledge representation formalism is an “ontology” formalized with OWL or RDF(s). In contrast to traditional database systems, the Semantic Web technologies require no static schema. Therefore, sensor information models can be dynamically changed and data from different sources (e.g., automation devices) can be easily combined and semantically integrated. Interfaces for accessing and manipulating information within each respective Logical Position Sensor may be defined based on well-established standards (e.g., W3C consortium, IEEE).

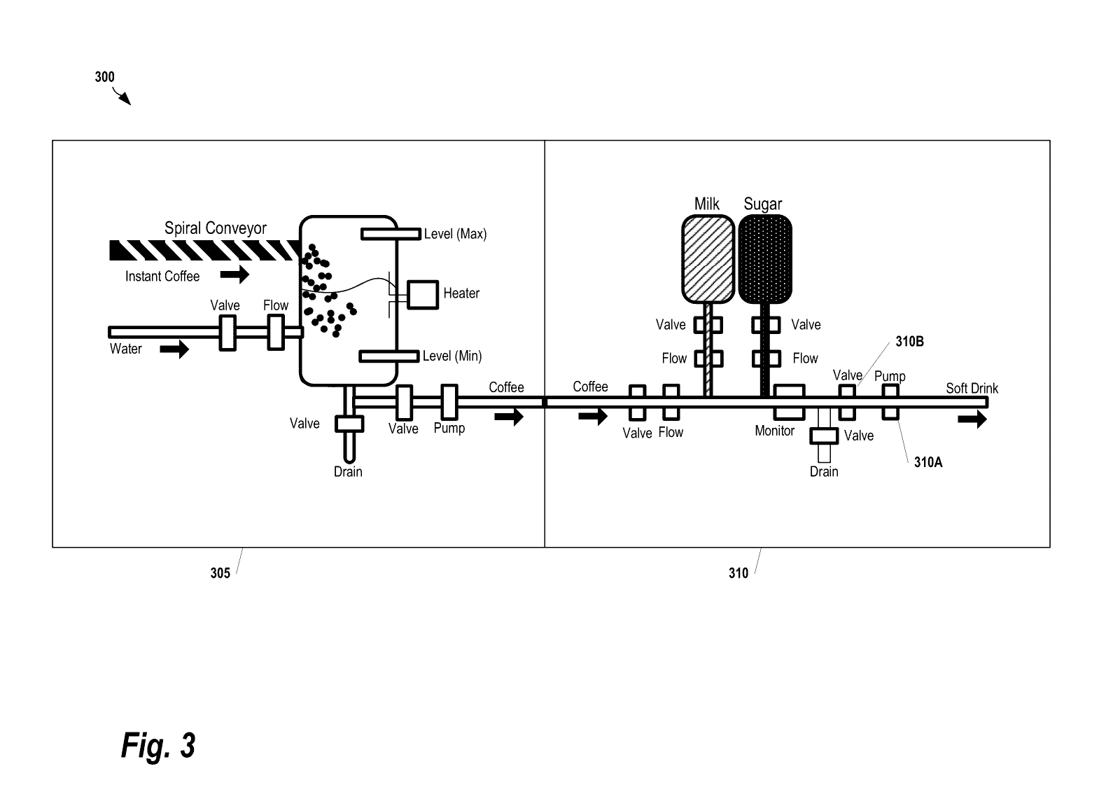

To illustrate one use of logical position sensors, FIG. 3 provides a diagram of a system that may be used for producing flavored coffee. This example shows a variety of devices (e.g., valves, flow control sensors, level sensors, pumps, etc.) used in the coffee brewing process. These devices are functionally divided into two portions a Coffee Brewing Portion 305 and a Flavoring Portion 310. Each of these devices may be associated with a logical position sensor. Thus, for example, the logical position sensor associated with the Pump 310A may include information indicating the Valve 310B immediately precedes it in the coffee production process. Additionally, the logical position sensor associated with the Pump 310A may specify that it's a member of a group of devices associated with flavoring coffee, along with the other devices in the Flavoring Portion 310. Using the sensor information provided by each logical position sensor, problems in the coffee brewing process may be identified by tracing the process through the device identifiers. It should be noted that the various valves, pumps, and sensors may be embedded in pipe or other physical objects, thus making visual detection difficult. However, using the sensor information provided by each logical position sensor, the geolocation of the various components can be readily identified.

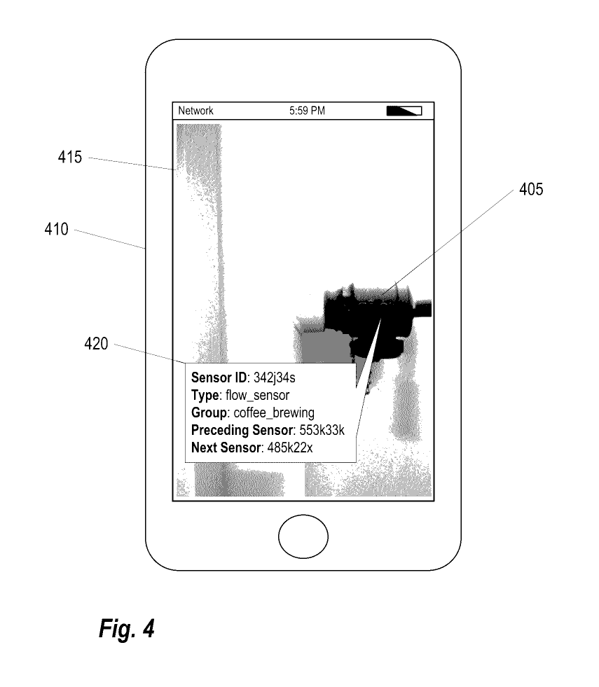

FIG. 4 provides an example of how information from a logical position sensor can be utilized to display relative information about an automation component, according to some embodiments. In this example, a flow sensor is embedded in a pipe 405 included in an automation system and Augmented Reality (AR) is used to display sensor information. As is well understood in the art, AR refers to a live direct or indirect view of a physical, real-world environment whose elements are augmented (or supplemented) by computer-generated information. In FIG. 4, the camera of the device 410 is used to capture a live image 415 of the physical location of the flow sensor. A graphical element 420 is overlaid on the live image 415 to display relevant sensor information. In this example, the sensor information includes the flow sensor's identifier, type, what group of devices it operates within, as well as the preceding logical position sensor and the next logical position sensor in the production sequence. The AR functionality may be provided, for example, by a specialized app running on a smartphone or tablet device. Thus, a user can travel through the automation environment and use the AR functionality to visually understand the operation of the various components of the automation system.

The logical position sensor described herein overcomes technical hurdles (access to remote engineering systems, different data models) and provides information about a plants structure in an efficient (caching), intuitive (sensor paradigm) and standardized way (standardized interface) to application developers. Due to the access to physical and logical position information, including distance metrics, abstracted from the I/O configuration of the sensor/actor in the automation system, automation engineers can develop completely original solutions for dynamic changing processes, plants and factories. Moreover, as applications can access IO through an API instead of direct read/write operation on the process image, debugging, simulation and development becomes easier.

Additionally, using the disclosed logical position sensor, dynamic reconfiguration of an automation system can be handled without costly reengineering of the automation system and production stops. With accurate location information of device, some devices can be reused for retrofitting projects. For maintenance professionals, it's easier to locate the target device in a short time. Automation applications can specify one or more abstract level which input they need for controlling the system and which output/control they provide for the system, instead then directly hard-coding the addresses of the respective hardware in the process image on the PLC. The PLC is enabled to dynamically assign the IO to the automation applications when the physical part of the system is reconfigured.

The various automation system devices described herein may include various hardware and software elements to facilitate use of logical position sensors. For example, devices may include one or more processors configured to execute instructions related to logical position sensor functionality. These processors may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The various automation system devices described herein may also include at least one computer readable medium or memory for holding instructions programmed according to embodiments of the invention and for containing data structures, tables, records, or other data described herein. The term “computer readable medium” as used herein refers to any medium that participates in providing instructions to one or more processors for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks. Non-limiting examples of volatile media include dynamic memory. Non-limiting examples of transmission media include coaxial cables, copper wire, and fiber optics, including the wires that make up a system bus. Transmission media may also take the form of acoustic or light waves, such as those generated during radio wave and infrared data communications.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically, wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A method of creating a logical position sensor for a component of an automation system, the method comprising:
determining, by an automation device, a unique identifier for the component;
determining, by the automation device, a geographical position of the component;
determining, by the automation device, a logical position of the component within a production process performed by the automation system;
creating, by the automation device, a logical position sensor for the component, wherein the logical position sensor comprises a sensor interface which provides access to the unique identifier, the geographical position of the component, and the logical position of the component.

2. The method of claim 1, further comprising:
retrieving, by the automation device, information from a Product Lifecycle Management System (PLM).

3. The method of claim 1, further comprising:
creating, by the automation device, a plurality of additional logical position sensors for each of a plurality of additional components in the automation system, wherein each respective additional logical position sensor comprises a distinct logical position of a corresponding component within the production process performed by the automation system.

4. The method of claim 3, further comprising:
receiving, by the automation device, a data processing request from an application associated with the component, wherein the data processing request requires information about a portion of the production process preceding the component;
using, by the automation device, the logical position sensor and the plurality of additional logical position sensors to identify a preceding component which directly precedes the component in the production process; and
sending, by the automation device, the data processing request to the preceding component.

5. The method of claim 3, further comprising:
receiving, by the automation device, a data processing request from an application associated with the component;
using, by the automation device, the logical position sensor and the plurality of additional logical position sensors to identify a subsequent component directly following the component in the production process; and
sending, by the automation device, the data processing request to the subsequent component.

6. The method of claim 1, further comprising:
retrieving, by the automation device, process configuration information associated with the production process from a remote engineering and planning system,
wherein the logical position of the component within the production process is determined based on the process configuration information.

7. The method of claim 1, further comprising:
retrieving, by the automation device, process configuration information associated with the production process from a local database operably coupled to the automation device,
wherein the logical position of the component within the production process is determined based on the process configuration information.

8. The method of claim 1, further comprising:
retrieving, by the automation device, process configuration information associated with the production process from one or more additional automation devices operably coupled to the automation device,
wherein the logical position of the component within the production process is determined based on the process configuration information.

9. The method of claim 1, wherein the automation device comprises a computing device embedded within the component.

10. The method of claim 1, wherein the automation device comprises a computing device operably coupled to the component over a network.

11. The method of claim 1, further comprising:
using an augmented reality application to overlay at least one of the unique identifier of the component, the geographical position of the component, and the logical position of the component on a live image of the component.

12. A system for providing logical position information corresponding to a component of an automation system, the system comprising:
a data acquisition component configured to:
retrieve process configuration information associated with a production process from one or more remote sources, and
generate logical position information using the process configuration information, the logical position information comprising a logical position of the component in the production process;
a database configured to store the process configuration information and the logical position information; and
a sensor interface configured to provide access to the logical position information.

13. The system of claim 12, wherein the one or more remote sources comprise a remote engineering and planning system.

14. The system of claim 12, wherein the one or more remote sources comprise one or more additional components of the automation system.

15. The system of claim 12, wherein the logical position information further comprises:
a unique identifier for the component; and
a geographical position of the component.

16. The system of claim 15, wherein the logical position information further comprises:
a first set of unique identifiers corresponding to one or more first components of the automation system directly preceding the component in the production process; and
a second set of unique identifiers corresponding to one or more second components of the automation system directly following the component in the production process.

17. The system of claim 12, wherein the data acquisition component, the database, and the sensor interface are included in a software application executing on the component.

18. An article of manufacture for creating a logical position sensor for a component of an automation system, the article of manufacture comprising a non-transitory, tangible computer-readable medium holding computer-executable instructions for performing a method comprising:
determining a unique identifier for the component;
determining a geographical position of the component;
determining a logical position of the component within a production process performed by the automation system;
creating a logical position sensor for the component, wherein the logical position sensor comprises a sensor interface which provides access to the unique identifier, the geographical position of the component, and the logical position of the component.

19. The article of manufacture of claim 18, wherein the method further comprises:
creating a plurality of additional logical position sensors for each of a plurality of additional components in the automation system, wherein each respective additional logical position sensor comprises a distinct logical position of a corresponding component within the production process performed by the automation system.

20. The article of manufacture of claim 19, wherein the method further comprises:
receiving a data processing request from an application associated with the component, wherein the data processing request requires information about a portion of the production process preceding the component;
using the logical position sensor and the plurality of additional logical position sensors to identify a preceding component directly preceding the component in the production process; and
sending the data processing request to the preceding component.

21. The article of manufacture of claim 19, wherein the method further comprises:
receiving a data processing request from an application associated with the component;
using the logical position sensor and the plurality of additional logical position sensors to identify a subsequent component directly following the component in the production process; and
sending the data processing request to the subsequent component.
